(19) United States
(12) Patent Application Publication
(10) Pub. No.: US 2018/0048632 A1
(43) Pub. Date: Feb. 15, 2018

(54) PRECURSORY CLIENT CONFIGURATION FOR NETWORK ACCESS

(71) Applicant: QUALCOMM Incorporated, San Diego, CA (US)

(72) Inventors: Rosario Cammarota, San Diego, CA (US); Olivier Jean Benoit, San Diego, CA (US); Peerapol Tinnakornsrisuphap, San Diego, CA (US)

(21) Appl. No.: 15/235,505

(22) Filed: Aug. 12, 2016

(51) Int. Cl. H04L 29/06; H04L 9/32

(52) U.S. Cl. CPC H04L 63/061; H04L 63/0435; H04L 9/3247; H04L 63/0442; H04L 63/029

(57) ABSTRACT

Methods, systems, and devices for wireless communication are described for precursory client configuration for network access. A configurator station (STA) may receive, from a key management device, an identity key of a client STA and may receive, from the client STA, a network configuration probe that includes a first cryptographic value based at least in part on the identity key and a request for network access. The configurator STA may apply a cryptographic function to the identity key to generate a second cryptographic value. The configurator STA may configure the client STA to access a network based at least in part on a match between the first cryptographic value and the second cryptographic value.

### BACKGROUND

The following relates generally to wireless communication, and more specifically to precursory client configuration for network access.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

The Wi-Fi Alliance is an organization promoting Wi-Fi technology and certifies wireless products that conform to specified interoperability standards. The Wi-Fi Alliance has developed Device Provisioning Protocol (DPP) to enable devices that do not have a rich user interface to gain access to a WLAN. In a typical scenario, a user powers on a DPP device and manually configures the DPP device to access the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of wireless communication, including. The method may include receiving, from a key management device, an identity key of a client device, receiving, from the client device, a network configuration beacon comprising a first cryptographic value based at least in part on the identity key and a request for network access, applying, by a configurator device, a cryptographic function to the identity key to generate a second cryptographic value, and configuring, by the configurator device, the client device to access a network based at least in part on a match between the first cryptographic value and the second cryptographic value.

Another innovative aspect of the subject matter described in this disclosure can be implemented in an apparatus for wireless communication. The apparatus may include means for receiving, from a key management device, an identity key of a client device, means for receiving, from the client device, a network configuration beacon comprising a first cryptographic value based at least in part on the identity key and a request for network access, means for applying, by a configurator device, a cryptographic function to the identity key to generate a second cryptographic value, and means for configuring, by the configurator device, the client device to access a network based at least in part on a match between the first cryptographic value and the second cryptographic value.

Another innovative aspect of the subject matter described in this disclosure can be implemented in an apparatus for wireless communication. The apparatus may include a processor, memory in electronic communication with the processor, and instructions stored in the memory. The instructions may be operable to cause the processor to receive, from a key management device, an identity key of a client device, receive, from the client device, a network configuration beacon comprising a first cryptographic value based at least in part on the identity key and a request for network access, apply, by a configurator device, a cryptographic function to the identity key to generate a second cryptographic value, and configure, by the configurator device, the client device to access a network based at least in part on a match between the first cryptographic value and the second cryptographic value.

Another innovative aspect of the subject matter described in this disclosure can be implemented in a non-transitory computer readable medium for wireless communication. The non-transitory computer-readable medium may include instructions operable to cause a processor to receive, from a key management device, an identity key of a client device, receive, from the client device, a network configuration beacon comprising a first cryptographic value based at least in part on the identity key and a request for network access, apply, by a configurator device, a cryptographic function to the identity key to generate a second cryptographic value, and configure, by the configurator device, the client device to access a network based at least in part on a match between the first cryptographic value and the second cryptographic value.

In some implementations, the method, apparatuses, and non-transitory computer-readable medium described above can further include processes, features, means, or instructions for authenticating the client device prior to configuring the client device to access the network.

In some implementations of the method, apparatuses, and non-transitory computer-readable medium described above, the identity key can be a public key that corresponds to a private key of the client device.

In some implementations, the method, apparatuses, and non-transitory computer-readable medium described above can further include processes, features, means, or instructions for receiving, from the key management device, a signature generated by the key management device using the private key of the client device.

In some implementations, the method, apparatuses, and non-transitory computer-readable medium described above can further include processes, features, means, or instructions for transmitting the signature to the client device. In some implementations, the method, apparatuses, and non-transitory computer-readable medium described above can further include processes, features, means, or instructions for receiving confirmation from the client device that the signature can be valid.

In some implementations of the method, apparatuses, and non-transitory computer-readable medium described above, configuring the client device includes: tunneling the identity key to an access point, wherein the configurator device configures the client device via the access point.

In some implementations, the method, apparatuses, and non-transitory computer-readable medium described above can further include processes, features, means, or instructions for accessing, by the configurator device, an online sales platform. In some implementations, the method, apparatuses, and non-transitory computer-readable medium described above can further include processes, features, means, or instructions for enabling, by the configurator device, a purchase of the client device via the online sales platform.

In some implementations, the method, apparatuses, and non-transitory computer-readable medium described above, the client device can be a device provisioning protocol (DPP) device.

In some implementations of the method, apparatus, and non-transitory computer-readable medium described above, the cryptographic function can be a hash function.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example of a system for wireless communication that supports precursory client configuration for network access in accordance with aspects of the present disclosure.

FIG. 2 illustrates an example of a wireless communication system that supports precursory client configuration for network access in accordance with aspects of the present disclosure.

FIG. 3 illustrates an example of a swim lane diagram that supports precursory client configuration for network access in accordance with aspects of the present disclosure.

FIG. 4 illustrates an example of a swim lane diagram that supports precursory client configuration for network access in accordance with aspects of the present disclosure.

FIGS. 5A-B illustrate block diagrams of a system including a station (STA) that supports precursory client configuration for network access in accordance with aspects of the present disclosure.

FIG. 6 illustrates a method for precursory client configuration for network access in accordance with aspects of the present disclosure.

### DETAILED DESCRIPTION

Easy to use and secure mechanisms are disclosed for providing client stations (STAs) with network access. Rather than requiring manual user configuration of a client STA, an identity key is used to automatically configure the client STA for accessing a network. A key management device stores identity keys for client STAs and passes an identity key corresponding to a particular client STA to a configurator STA. One example of a key management device is a key management server. The configurator STA has authority for configuring the client STA to access a network, such as a wireless local area network (WLAN). The configurator STA may be a device having a rich user interface (e.g., a smartphone with a touchscreen) and may be used by a user to purchase the client STA from an online sales platform. The client STA may be, for example, a device that a user controls with a smartphone via the WLAN. As part of the purchase, the online sales platform informs the key management server of a device serial number of the client STA being bought. The key management server uses the device serial number to identify an identity key associated with the client STA and forwards the identity key to the configurator STA.

At some later time, the user powers on the client STA. The client STA stores its identity key, which may be the same identity key as stored by the key management server, and broadcasts a configuration request probe. To protect the identity key, the probe may include a value that is a cryptographic function of the identity key (e.g., a one-way hash), instead of the identity key itself. Sending the cryptographic value, instead of the identity key, prevents unauthorized STAs from configuring the client STA. The configurator STA receives the probe and retrieves the cryptographic value from the probe. To confirm that it has the appropriate identity key to configure the client STA, the configurator STA performs the same cryptographic function on the identity key received from the key management server to generate comparison cryptographic value. If the probe's cryptographic value matches the comparison cryptographic value, the configurator STA initiates a configuration procedure to automatically provision the client STA with access to the WLAN.

In an example, a configurator STA may perform a method for wireless communication that includes automatically configuring a client STA. The configurator STA may receive, from a key management device, an identity key of a client STA and may receive, from the client STA, a network configuration probe that includes a first cryptographic value based at least in part on the identity key and a request for network access. The configurator STA may apply a cryptographic function to the identity key to generate a second cryptographic value. The configurator STA may configure the client STA to access a network based at least in part on a match between the first cryptographic value and the second cryptographic value.

Aspects of the disclosure are initially described in the context of a wireless communications system. The wireless communications system may share an identity key with a configurator STA for automatically provisioning a client STA with network access. Aspects of the disclosure are further illustrated by and described with reference to apparatus diagrams, system diagrams, and flowcharts that relate to precursory client configuration for network access.

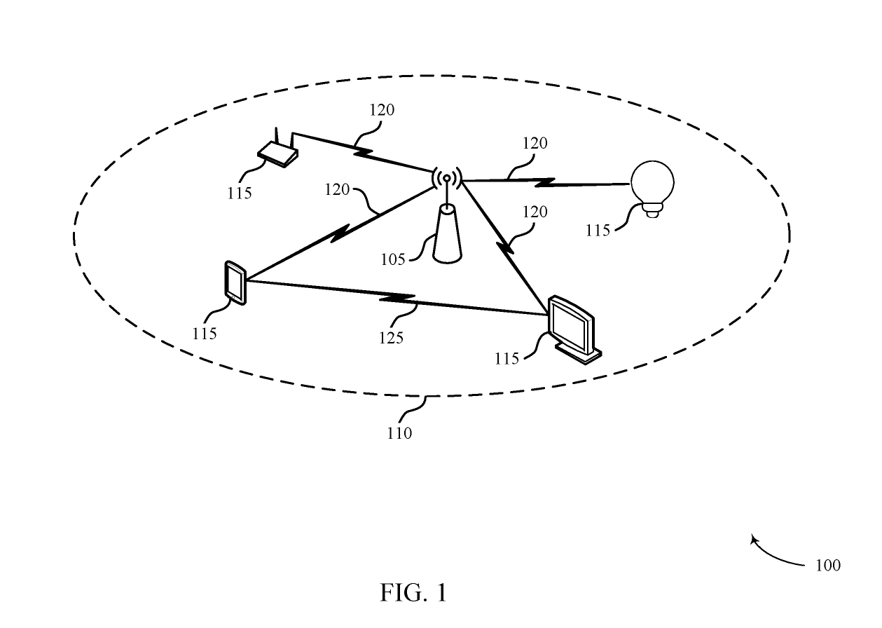

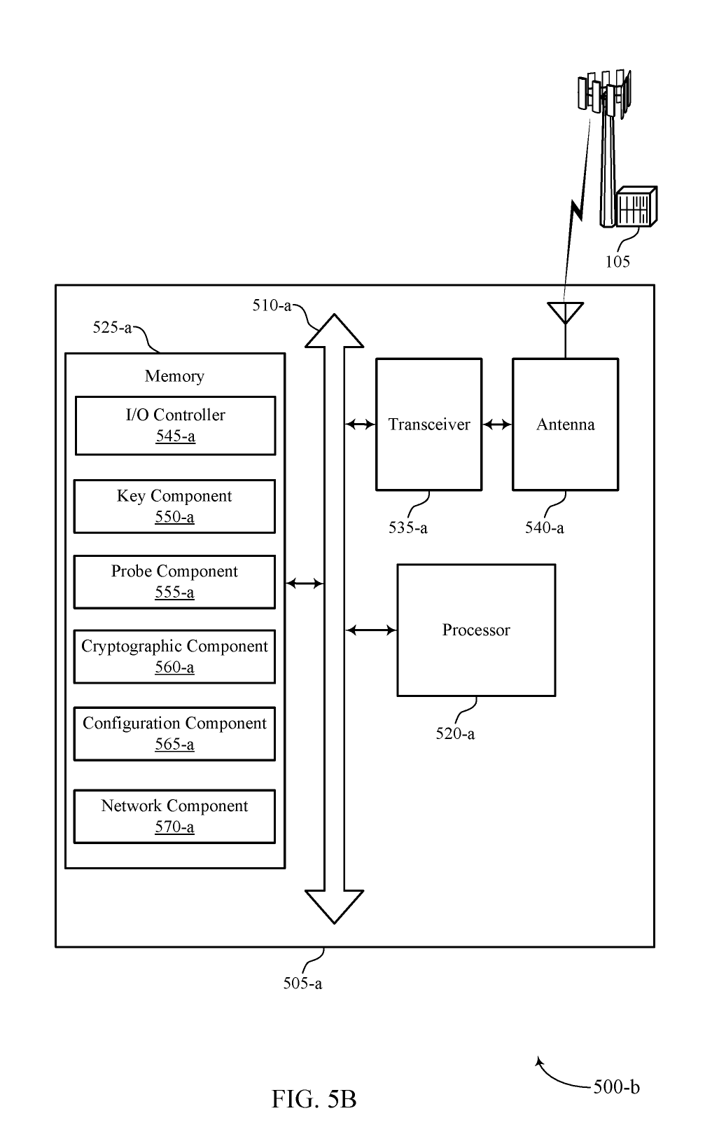

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, smartphones, personal digital assistant (PDAs), other handheld devices, netbooks, notebook computers, tablet computers, laptops, display devices (e.g., TVs, computer monitors, etc.), DPP devices, network-enabled light bulbs, printers, etc. The AP 105 and the associated stations 115 may represent a basic service set (BSS) or an extended service set (ESS). An ESS is a set of connected BSSs. The various STAs 115 in the network are able to communicate with one another through the AP 105. An extended network station (not shown) associated with the WLAN 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

Digital Home is a term used to refer to the trend of networked consumer electronics found in a home. STAs within a Digital home communicate with each other and may be controlled by a user to enhance a living space. STAs range from televisions to set top boxes, notebook computers to audio systems, cameras to digital photo frames, light bulbs to refrigerators, and much more. Wi-Fi is a key technology for connecting the Digital Home. The sophistication of user interfaces of STAs may vary widely and may impact how easy it is to configure a STA to access a WLAN. A smartphone STA, for instance, may have a rich user interface (e.g., touchscreen graphical user interface). A network-controllable light bulb, in contrast, may have a limited user interface. A STA having a limited user interface may require a user to use a completely different device to provision such a STA to access a WLAN. A STA having a rich user interface and capable of provisioning other STAs with access to a WLAN via AP 105 is referred to herein as a configurator STA. A STA having a limited user interface is referred to herein as a client STA.

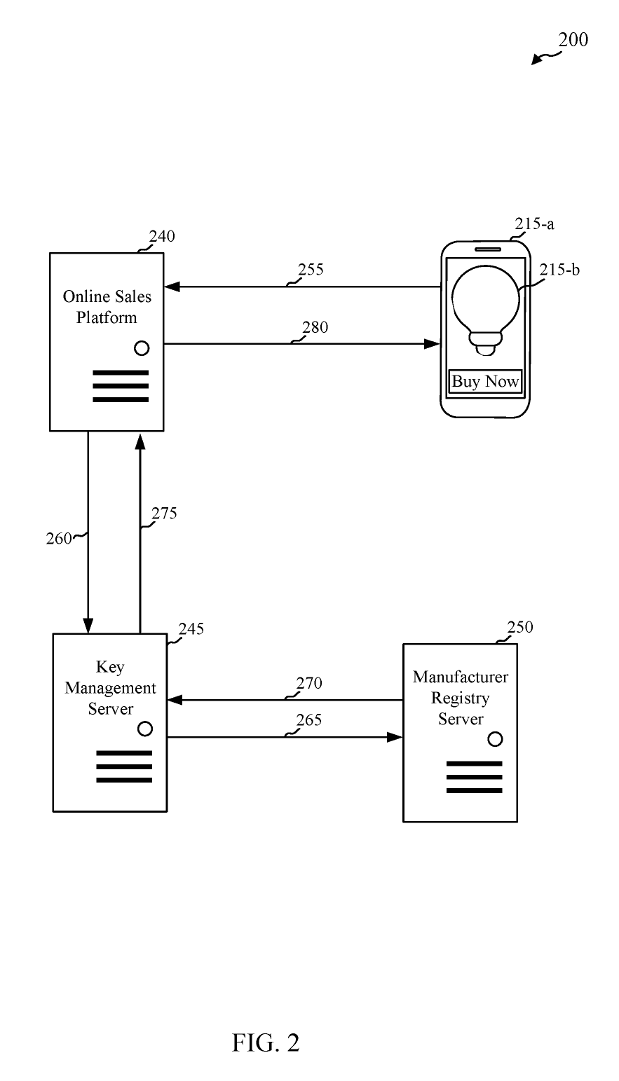

The example embodiments may provide easy to use and secure mechanisms for provisioning client STAs with network access. FIG. 2 illustrates an example of a wireless communication system 200 for precursory client configuration for network access. The wireless communication system 200 may assist a user, beginning with purchasing a client STA all the way through provisioning the client STA with network access. Configurator STA 215-a is an example of a STA 115 having a rich user interface, as described in FIG. 1. Links 255, 260, 265, 270, 275, and 280 shown in FIG. 2 may represent communication over one or more computer networks using one or more protocols (e.g., WLAN, wide area network (WAN), wireless WAN, LTE network, cellular network, Ethernet, and the like).

At some time, a user of configurator STA 215-a connects to an online sales platform 240 and browses products available for purchase. In an example, the online sales platform 240 may be a server configured to provide a graphical user interface (e.g., a website) that may be used to browse and purchase products. In one instance, the user shops for a client STA, depicted in the graphical user interface as reference numeral 215-b. Client STA 215-b is an example of a STA 115 having a limited user interface, as described in FIG. 1. The client STA 215-b is configurable to access a wireless local area network via an access point 105 (e.g., Wi-Fi network at a user's home, a worksite, etc.). In an example, the client STA 215-b may be a device provisioning protocol (DPP) device that the user may control via a network using the configurator STA 215-a. For example, the configurator STA 215-a turns on and off a light bulb client STA via the network. Configurator STA 215-a may have authority to provision STAs to access the network. The network is described herein as a WLAN, but may be any type of network.

When the user selects to purchase a particular product, such as a client STA 215-b (depicted as a DPP light bulb), the configurator STA 215-a sends a purchase request message 255 to the online sales platform 240 that may include a payment credential. Upon successful verification of the payment credential, online sales platform 240 may retrieve an identity key associated with the client STA 215-b. The online sales platform 240 communicates the identity key to the configurator STA 215-a for use in automatically configuring the client STA 215-b to access a WLAN.

To retrieve the identity key, the online sales platform 240 receives and processes the purchase request message 255 and identifies a device serial number of the client STA 215-b being bought. The online sales platform 240 generates and forwards an identity key request that includes the device serial number to a key management server 245. The device serial number may uniquely identify the client STA 215-b, and corresponds to a unique identity key assigned to the client STA 215-b. The unique identity key is stored by the key management server 245. The key management server 245 may include a repository of identity keys that are uniquely associated with client STAs 215. The key management server 245 may uniquely link the identity key with the device serial number of the client STA 215-b and a chip serial number of a wireless chip installed on the client STA 215-b. For example, a client STA 215-b stores its identity key in a wireless chip and the key management server 245 stores a copy of the identity key. In a more detailed example, the identity key may be a public key of a public/private key pair. The wireless chip may have a chip serial number that is unique to a particular wireless chip installed in the client STA 215.

The key management server 245 retrieves the identity key of client STA 215-b using the device serial number and the chip serial number. In an example, the key management server 245 stores a database that contains database records uniquely linking a device serial number to a chip serial number and an identity key. The key management server 245 looks up the identity key corresponding to the received device serial number.

In other examples, the key management server 245 may only be aware of which chip serial number corresponds to which identity key, and may be unaware of which device serial number corresponds to which chip serial number. In such a scenario, key management server 245 contacts a third party to determine the correspondence between device serial numbers and chip serial numbers. For example, the key management server 245 generates and transmits a chip serial number request 265 to a manufacturer registry server 250 that includes the device serial number of client STA 215-b. The manufacturer registry server 250 maintains a database including database records indicating which device serial number corresponds to which chip serial number. The manufacturer registry server 250 receives the chip serial number request 265, retrieves the device serial number, and identifies the chip serial number that uniquely corresponds to the device serial number. The manufacturer registry server 250 generates and transmits, to the key management server 245, a chip serial number response 270 that includes the chip serial number corresponding to the device serial number of client STA 215-b.

The key management server 245 receives the chip serial number response 270 and extracts the chip serial number, and queries its database to retrieve the identity key corresponding to the received chip serial number. The key management server 245 returns the identity key to the online sales platform 240. For example, the identity key may be a public key of a public/private key pair and the key management server 245 may send the public key, but not the private key, to the online sales platform 240.

The key management server 245 maintains the private key a secret so that the client STA 215-b may use the private key locally stored by its wireless chip to validate the public identity key provided to the configurator STA 215-a. In an example, the key management server 245 generates an electronic signature to permit validation of the public identity key it provides to configurator STA 215-a. The key management server 245 generates an electronic signature as a function of the public identity key and the private key of the client STA 215-b. The key management server 245 uses the public identity key and the private key as inputs to a cryptographic function that outputs a cryptographic value that serves as the electronic signature. In an example, the key management server 245 produces a one-way hash of the public identity key and encrypts the hash using the private key to generate the electronic signature. The key management server 245 generates and transmits a key message 275 to the online sales platform 240 that includes the public identity key of the client STA 215-b and the electronic signature. To protect the key message 275, the key management server 245 and the online sales platform 240 may establish a secure connection. The online sales platform 240 generates and sends a configuration message 280 to the configurator STA 215-a that includes the public identity key of the client STA 215-b and the electronic signature. To protect the configuration message 280, the online sales platform 240 and the configurator STA 215-a may establish a secure connection.

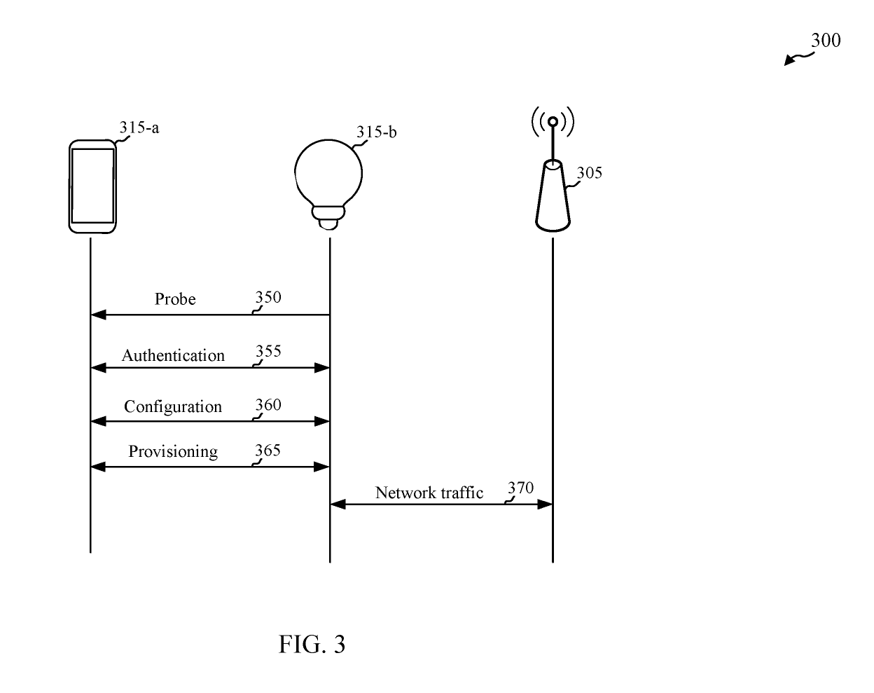

The configurator STA 215-a uses the public identity key of the client STA 215-b and the electronic signature to provision the client STA 215-b with network access. After the client STA 215-b is shipped to the user, is powered on, and is within range of an access point, the configurator STA 215-a may automatically configure client STA 215-b to access the WLAN via the access point. FIG. 3 illustrates an example of a swim lane diagram 300 for precursory client configuration for network access. Configurator STA 315-a and client STA 315-b are examples of STAs 115, 215 as described in FIGS. 1-2. AP 305 is an example of APs 105, 205 as described in FIGS. 1-2.

After being powered on, client STA 315-b automatically transmits a network configuration probe 350 at periodic and/or aperiodic intervals. The network configuration probe 350 may request network access and include a cryptographic value. Client STA 315-b generates the cryptographic value by applying a cryptographic function to the public identity key stored by its wireless chip. The probe 350 may include the cryptographic value of the public identity key, instead of the public identity key, to prevent an unauthorized STA from configuring, or attempting to configure, the client STA 315-b. In DPP, for example, a first device that configures a DPP device may control the DPP device, and thus a user may want the configurator STA 315-a, and not some other STA, controlling client STA 315-b. The cryptographic function may be, for example, a hash of the public identity key generated using a one-way hash function.

After the probe 350 is received, the configurator STA 315-a determines whether the public identity key received from the key management server 245 (“candidate public identity key) is the same as the public identity key stored by the client STA 315-b. Because the probe 350 includes the cryptographic value of the public identity key, and not the public identity key stored by the client STA 315-b, the configurator STA 315-a applies the same cryptographic function as applied by the client STA 315-b to generate a candidate cryptographic value. If the candidate cryptographic value matches the probe's cryptographic value, the configurator STA 315-a determines that it has the public identity key of the client STA 315-b and initiates automatic configuration of the client STA 315-b for access to a WLAN.

Automatic configuration may begin with an authentication procedure. In an example, the configurator STA 315-a exchanges one or more authentication messages 355 with the client STA 315-b (e.g., performs DPP authentication). To initiate authentication, the configurator STA 315-a communicates to the client STA 315-b the electronic signature received from the key management server 245. The client STA 315-b may use its locally stored public/private key pair to determine whether the client STA 315-b can recreate the same electronic signature, and hence validate the received electronic signature. To do so, the client STA 315-b applies the same cryptographic function as the key management server 245 to generate an electronic signature. The client STA 315-b compares the electronic signature it generated with the electronic signature received from the configurator STA 315-a. If the electronic signatures match, the client STA 315-b determines that it is able to successfully authenticate the configurator STA 315-a. Otherwise, authentication fails. The client STA 315-b sends an authentication response to the configurator STA 315-a indicating whether the electronic signature was valid and/or whether authentication was successful.

If successfully authenticated, the configurator STA 315-a performs a configuration procedure to configure the client STA 315-b for accessing a network via an access point 305 (e.g., performs DPP configuration). For example, the configurator STA 315-a sends configuration data to the client STA 315-b in one or more configuration messages 360. The configuration data may include, for example, settings for wireless access, such as a service set identifier (SSID) of the AP 305, channel, power settings, and the like. The configuration data may also include additional information for security, application layer, or other settings used by the client STA 315-b to communicate via the AP 305.

Subsequent to configuration, the configurator STA 315-a may perform a provisioning procedure to provision the client STA 315-b with network access via the access point 305 (e.g., performs DPP provisioning). The process of granting network access may be referred to as device provisioning. In an example, configurator STA 315-a may set up a secure wireless connection with client STA 315-b via AP 305, provide the client STA 315-b with a key for communicating messages via the access point 305, and the like. Once provisioned, the client STA 315-b may have access to a WLAN via the AP 305 and may exchange network traffic 370 via the WLAN.

In another example, instead of or in addition to the configurator STA 315-a receiving the public identity key and the electronic signature from the key management server 245, the client STA 315-b may receive the public identity key and the electronic signature from the key management server 245. This may occur, for example, if the client STA 315-b has a rich user interface. The client STA 315-b may then may tunnel the identity key to the configurator STA 315-a via a tunneling procedure (e.g., DPP tunneling). The client STA 315-b may authenticate the received electronic signature (e.g., confirm that a received electronic signature is valid). If successfully authenticated, the client STA 315-b and the configurator STA 315-a may perform the configuration and provisioning procedures discussed above to provision the client STA 315-b to access to the WLAN.

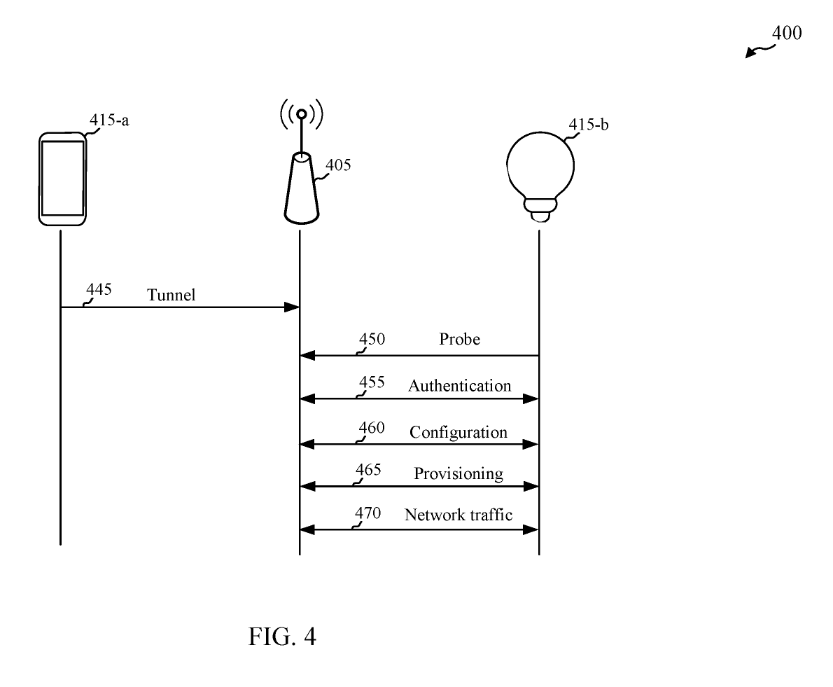

In some examples, a configurator STA may delegate authority to configure a client STA to another device. FIG. 4 illustrates an example of a swim lane diagram 400 for precursory client configuration for network access. In the depicted example, configurator STA 415-a may delegate authority to AP 405 to configure client STA 415-b. STAs 415-a, 415-b are examples of STAs 115, 215, 315 described in FIGS. 1-3, and AP 405 is an example of APs 105, 305 described in FIGS. 1-3.

To delegate authority, the configurator STA 415-a tunnels the public identity key received from the key management server 245 to the access point 405. For example, configurator STA 415-a sends a tunnel message 445 to the access point 405 that includes the public identity key of client STA 415-b and the electronic signature received from the key management server 245. The AP 405 may be considered a configurator and may perform the authentication, configuration, and provisioning procedures discussed above to configure client STA 415-b. For example, the client STA 415-b may send a configuration request probe 450, and the access point 405 may receive and process the probe, similar to the description of how configurator STA 315-a processed the probe described above with reference to FIG. 3. In this example, the access point 405, instead of configurator STA 415-a, may also perform the procedures of authentication 455, configuration 460, and provisioning 465, similar to the description provided above in FIG. 3. After being provisioned, the client STA 415-b may have network access via the access point 405 and may exchange network traffic 470.

In other examples, the access point 405 may act as an intermediary, rather than an active participant, that merely forwards messages between the configurator STA 415-a and the client STA 415-b. In such an example, the access point 405 may receive the configuration request probe from the client STA 415-b and forward the probe to the configurator STA 415-a for processing. The access point 405 may similarly pass messages between the configurator STA 415-a and the client STA 415-b during the operations of authentication 455, configuration 460, and provisioning 465.

Advantageously, the example embodiments provide a secure and easy to use mechanism for automatically configuring a client STA to access a network.

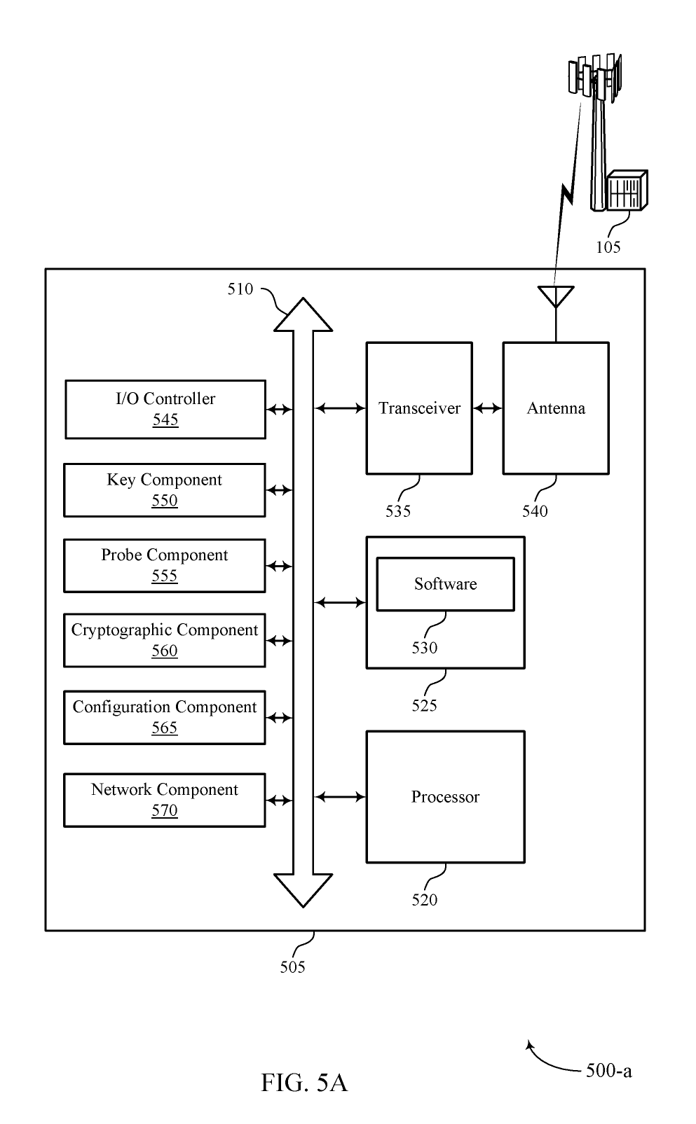

FIG. 5A shows a diagram of a system 500-a including a device 505 that supports precursory client configuration for network access in accordance with various aspects of the present disclosure. Device 505 may be an example of or include the components of configurator STA 115 as described above, e.g., with reference to FIGS. 1-4. Device 505 may include components for bi-directional voice and data communications including components for transmitting and receiving communications, including processor 520, memory 525, software 530, transceiver 535, antenna 540, and I/O controller 545. Device 505 may also include key component 550, probe component 555, cryptographic component 560, configuration component 565, and network component 570. These components may be in electronic communication via one or more busses (e.g., bus 510). Device 505 may communicate wirelessly with one or more access points 105.

Processor 520 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 520 may be configured to operate a memory array using a memory controller. In other cases, a memory controller may be integrated into processor 520. Processor 520 may be configured to execute computer-readable instructions stored in a memory to perform various functions (e.g., functions or tasks supporting precursory client configuration for network access).520.

Memory 525 may include random access memory (RAM) and read only memory (ROM). The memory 525 may store computer-readable, computer-executable software 530 including instructions that, when executed, cause the processor to perform various functions described herein. In some cases, the memory 525 may contain, among other things, a Basic Input-Output system (BIOS) which may control basic hardware and/or software operation such as the interaction with peripheral components or devices.

Software 530 may include code to implement aspects of the present disclosure, including code to support precursory client configuration for network access. Software 530 may be stored in a non-transitory computer-readable medium such as system memory or other memory. In some cases, the software 530 may not be directly executable by the processor but may cause a computer (e.g., when compiled and executed) to perform functions described herein.

Transceiver 535 may communicate bi-directionally, via one or more antennas, wired, or wireless links as described above. For example, the transceiver 535 may represent a wireless transceiver and may communicate bi-directionally with another wireless transceiver. The transceiver 535 may also include a modem to modulate the packets and provide the modulated packets to the antennas for transmission, and to demodulate packets received from the antennas.

In some cases, device 505 may include a single antenna 540. However, in some cases device 505 may have more than one antenna 540, which may be capable of concurrently transmitting or receiving multiple wireless transmissions.

I/O controller 545 may manage input and output signals for device 505. I/O controller 545 may also manage peripherals not integrated into device 505. In some cases, I/O controller 545 may represent a physical connection or port to an external peripheral. In some cases, I/O controller 545 may utilize an operating system such as iOS®, ANDROID®, MS-DOS®, MS-WINDOWS®, OS/2®, UNIX®, LINUX®, or another known operating system.

Key component 550, probe component 555, cryptographic component 560, configuration component 565, and network component 570 implement the features described with reference to FIGS. 1-4 and 6, as further explained herein.

Again, FIG. 5A shows only one possible implementation of a device executing the features of FIGS. 1-4 and 6. While the components of FIG. 5A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 5A may be implemented by a single, consolidated hardware block. For example, a single transceiver 535 chip may implement processor 520, memory 525, key component 550, probe component 555, cryptographic component 560, configuration component 565, and network component 570.

In still other examples, the features of each component may also be implemented, in whole or in part, with instructions embodied in a memory, formatted to be executed by one or more general or application-specific processors. For example, FIG. 5B shows a block diagram 500-b of another example of a device 505-a in which the features of the key component 550-a, probe component 555-a, cryptographic component 560-a, configuration component 565-a, and network component 570-a are implemented as computer-readable code stored on memory 525-a and executed by one or more processors 520-a. Other combinations of hardware/software may be used to perform the features of one or more of the components of FIGS. 5A-5B.

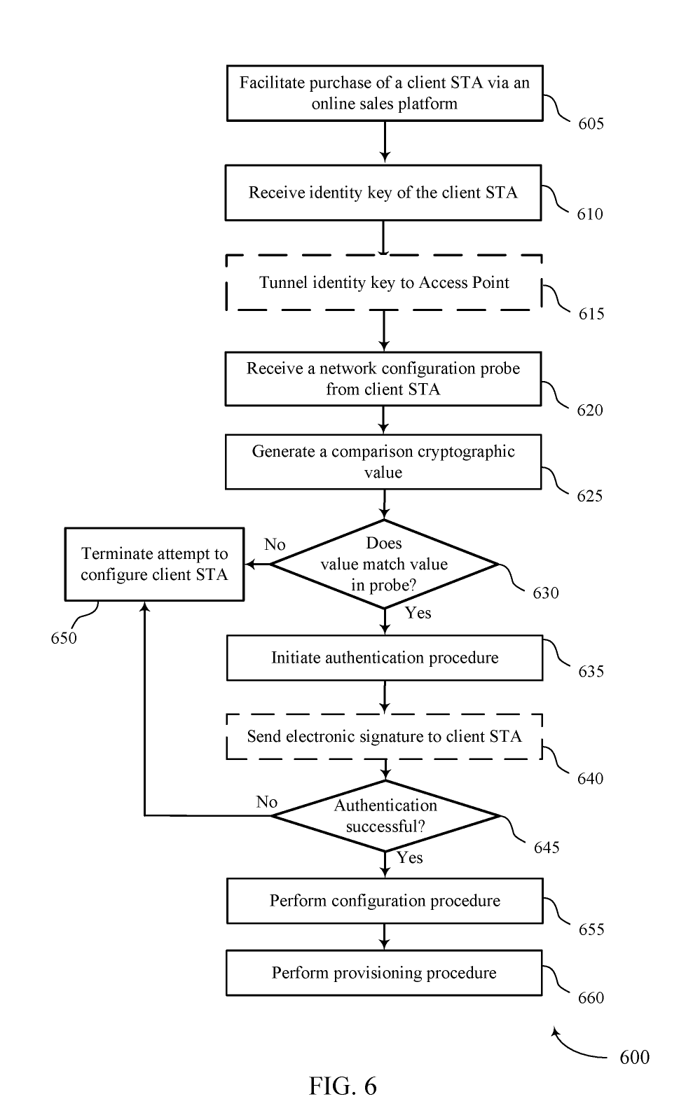

FIG. 6 shows a flowchart illustrating a method 600 for precursory client configuration for network access in accordance with various aspects of the present disclosure. The operations of method 600 may be implemented by a configurator STA 315 or its components as described herein. For example, the operations of method 600 may be performed by a configurator STA 315-a. In some examples, a configurator STA 315-a may execute a set of codes to control the functional elements of the device to perform the functions described below. Additionally or alternatively, the configurator STA 315-a a may perform aspects the functions described below using special-purpose hardware.

At block 605, network component 570 of configurator STA 315-a connects to and facilitates purchase of a client STA 315-b from an online sales platform 240. In an example, network component 570 may access an online sales platform 240 via antenna 540 and transceiver 535 and enable a purchase of a client device (e.g., client STA) via the online sales platform.

At block 610, key component 550 of configurator STA 315-a receives, via antenna 540 and transceiver 535, an identity key of the client STA 315-b. The identity key may be a public key of a public/private key pair that is stored by a key management server 245 and by a wireless chip of the client STA 315-b. The configurator STA 315-a may receive the identity key from the key management server 245 and/or via an intermediary, such as the online sales platform 240. In some examples, configurator STA 315-a may also receive an electronic signature generated by key management server 245 using the private key of client STA 315-b.

At block 615, key component 550 of configurator STA 315-a may optionally tunnel the received identity key to another device, such as an access point 305, via antenna 540 and transceiver 535. In such an example, the configurator STA 315-a may delegate authority to configure the client STA 315-b to the access point 305 and the access point 305 may provision the client STA 315-b with network access independent of configurator STA 315-a. In another example, access point 305 may act as an intermediary that passes communications between configurator STA 315-a and client STA 315-b during configuration.

At block 620, probe component 555 of configurator STA 315-a receives, from a client STA 315-b via antenna 540 and transceiver 535, a network configuration probe. The probe includes a request for network access and a cryptographic value. The client STA 315-b may have generated the cryptographic value by a applying a cryptographic function (e.g., a one-way hash function) to the identity key.

At block 625, cryptographic component 560 of configurator STA 315-a applies a cryptographic function to the identity key received from the key management server 245 to generate a comparison cryptographic value. In an example, cryptographic component 560 may apply a cryptographic function (e.g., same one-way hash) to the identity key received from the key management server 245. The cryptographic function may be the same function as applied by the client STA 315-b to the public key stored on the wireless chip.

At block 630, configuration component 565 of configurator STA 315-a determines whether the comparison cryptographic value matches the cryptographic value in the network configuration probe. If no match is detected, the method 600 proceeds to block 650 and configuration component 565 terminates attempting to configure client STA 315-b. If a match is detected, the method 600 proceeds to block 635.

At block 635, configuration component 565 of configurator STA 315-a initiates an authentication procedure for authenticating the client STA 315-b.

At block 640, as an optional part of the authentication procedure, configuration component 565 instructs transceiver 535 of configurator STA 315-a to send the electronic signature to the client STA 315-b via antenna 540.

At block 645, configuration component 565 of configurator STA 315-a determines whether it was able to successfully authenticate the client STA 315-b. If unsuccessful, the method 600 proceeds to block 650 and configuration component 565 terminates attempting to configure client STA 315-b. If successful, the method 600 proceeds to block 655.

At block 655, configuration component 565 of configurator STA 315-a performs a configuration procedure. For example, configuration component 565 sends configuration data to the client STA 315-b in one or more configuration messages. The configuration data may include, for example, settings for wireless access, such as a service set identifier (SSID) of the AP 305, channel, power settings, and the like. The configuration data may also include additional information for security, application layer, or other settings used by the client STA 315-b to communicate via the AP 305.

At block 660, configuration component 565 of configurator STA 315-a performs a provisioning procedure. In an example, configuration component 565 may set up a secure wireless connection with client STA 315-b via access point 305, provide the client STA 315-b with a key for communicating messages via the access point 305, and the like. Once provisioned, the client STA 315-b may have access to a WLAN via the AP 305 and may exchange network traffic via the WLAN. The method 600 may then end or repeat one or more times.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving, from a key management device, an identity key of a client device;
receiving, from the client device, a network configuration probe comprising a first cryptographic value based at least in part on the identity key and a request for network access;
applying, by a configurator device, a cryptographic function to the identity key to generate a second cryptographic value; and
configuring, by the configurator device, the client device to access a network based at least in part on a match between the first cryptographic value and the second cryptographic value.

2. The method of claim 1, further comprising:
authenticating the client device prior to configuring the client device to access the network.

3. The method of claim 1, wherein
the identity key is a public key that corresponds to a private key of the client device.

4. The method of claim 3, further comprising:
receiving, from the key management device, a signature generated by the key management device using the private key of the client device.

5. The method of claim 4, further comprising:
transmitting the signature to the client device; and
receiving confirmation from the client device that the signature is valid.

6. The method of claim 1, wherein configuring the client device comprises:
tunneling the identity key to an access point, wherein the configurator device configures the client device via the access point.

7. The method of claim 1, further comprising:
accessing, by the configurator device, an online sales platform; and
enabling, by the configurator device, a purchase of the client device via the online sales platform.

8. The method of claim 1, wherein the client device is a device provisioning protocol (DPP) device.

9. A communications device for wireless communication, comprising:
means for receiving, from a key management device, an identity key of a client device;
means for receiving, from the client device, a network configuration probe comprising a first cryptographic value based at least in part on the identity key and a request for network access;
means for applying a cryptographic function to the identity key to generate a second cryptographic value; and
means for configuring the client device to access a network based at least in part on a match between the first cryptographic value and the second cryptographic value.

10. The communications device of claim 9, further comprising:
means for authenticating the client device prior to configuring the client device to access the network.

11. The communications device of claim 9, wherein the identity key is a public key that corresponds to a private key of the client device.

12. The communications device of claim 11, further comprising:
means for receiving, from the key management device, a signature generated by the key management device using the private key of the client device.

13. The communications device of claim 12, further comprising:
means for transmitting the signature to the client device; and
means for receiving confirmation from the client device that the signature is valid.

14. The communications device of claim 9, wherein means for configuring the client device comprises:
means for tunneling the identity key to an access point, wherein the means for configuring the client device configures the client device via the access point.

15. The communications device of claim 9, further comprising:
means for accessing an online sales platform; and
means for enabling a purchase of the client device via the online sales platform.

16. The communications device of claim 9, wherein the client device is a device provisioning protocol (DPP) device.

17. An communications device for wireless communication, in a system comprising:
a processor and memory communicatively coupled to the processor, the memory comprising computer-readable code that, when executed by the processor, causes the communications device to:
receive, from a key management device, an identity key of a client device;
receive, from the client device, a network configuration probe comprising a first cryptographic value based at least in part on the identity key and a request for network access;
apply a cryptographic function to the identity key to generate a second cryptographic value; and
configure the client device to access a network based at least in part on a match between the first cryptographic value and the second cryptographic value.

18. The communications device of claim 17, wherein the instructions are further executable by the processor to:
authenticate the client device prior to configuring the client device to access the network.

19. The communications device of claim 17, wherein the identity key is a public key that corresponds to a private key of the client device.

20. The communications device of claim 19, wherein the instructions are further executable by the processor to:
receive, from the key management device, a signature generated by the key management device using the private key of the client device.

21. The communications device of claim 20, wherein the instructions are further executable by the processor to:
transmit the signature to the client device; and
receive confirmation from the client device that the signature is valid.

22. The communications device of claim 17, wherein configuring the client device comprises:
tunneling the identity key to an access point for configuring the client device via the access point.

23. The communications device of claim 17, wherein the instructions are further executable by the processor to:
access an online sales platform; and
enable a purchase of the client device via the online sales platform.

24. The communications device of claim 17, wherein the client device is a device provisioning protocol (DPP) device.

25. A non-transitory computer readable medium comprising computer-readable code that, when executed, causes a device to:
receive, from a key management device, an identity key of a client device;
receive, from the client device, a network configuration probe comprising a first cryptographic value based at least in part on the identity key and a request for network access;
apply a cryptographic function to the identity key to generate a second cryptographic value; and
configure the client device to access a network based at least in part on a match between the first cryptographic value and the second cryptographic value.

26. The non-transitory computer-readable medium of claim 25, wherein the instructions are further executable by the processor to:
authenticate the client device prior to configuring the client device to access the network.

27. The non-transitory computer-readable medium of claim 25, wherein the identity key is a public key that corresponds to a private key of the client device.

28. The non-transitory computer-readable medium of claim 27, wherein the instructions are further executable by the processor to:
receive, from the key management device, a signature generated by the key management device using the private key of the client device.

29. The non-transitory computer-readable medium of claim 28, wherein the instructions are further executable by the processor to:
transmit the signature to the client device; and
receive confirmation from the client device that the signature is valid.

30. The non-transitory computer-readable medium of claim 25, wherein configuring the client device comprises:
tunneling the identity key to an access point for configuring the client device via the access point.

31. The non-transitory computer-readable medium of claim 25, wherein the instructions are further executable by the processor to:
access an online sales platform; and
enable a purchase of the client device via the online sales platform.

32. The non-transitory computer-readable medium of claim 25, wherein the client device is a device provisioning protocol (DPP) device.
